(19) United States
(12) Patent Application Publication
(10) Pub. No.: US 2012/0222695 A1
(43) Pub. Date: Sep. 6, 2012

(54) WASHING DEVICE FOR HUMANS AND ANIMALS

(76) Inventor: Michael P. Suter, Hershey, PA (US)

(21) Appl. No.: 13/225,370

(22) Filed: Sep. 2, 2011

Related U.S. Application Data
(63) Continuation of application No. 12/545,058, filed on Aug. 20, 2009, now abandoned.
Application No. 12/545,058 is a continuation-in-part of application No. PCT/US2008/002195, filed on Feb. 20, 2008.
(60) Provisional application No. 60/902,226, filed on Feb. 20, 2007.

(51) Int. Cl. A45D 7/00; A01K 13/00; B05B 7/28

(52) U.S. Cl. 132/200; 239/310; 119/651

(57) ABSTRACT

A washing device [1000] is described which is uniquely adapted for use by elderly, handicapped, or other users which use one hand for support and have only one hand free to operate the device. The supply line [1010] directs the fluid to a fluid valve [1210] which is controlled by a first clicking mechanism 1231 which toggles the valve between an “open” position directing fluid flow to an additive valve [1240], and a “closed” position which stops fluid flow. Additive valve [1240] is also toggled between two positions by a second clicking mechanism [1232]. In its ‘fluid only’ position, only fluid is allowed to pass out of the additive valve [1240] through a mixing chamber [1400] and out of a changeable head [1700] to the user. In another embodiment, a single three-position valve performs the same functions.

### CROSS REFERENCE TO RELATED APPLICATIONS

The present application is a continuation of U.S. patent application Ser. No. 12/545,058, filed on Aug. 20, 2009, which is hereby incorporated by reference as if set forth in its entirety herein, which is a continuation of International Application PCT/US2008/002195, with an international filing date of Feb. 20, 2008, which is hereby incorporated by reference as if set forth in its entirety herein, which is related to or a continuation-in part of, and claims priority from U.S. Provisional Patent Application Ser. No. 60/902,226 filed Feb. 20, 2007 which is hereby incorporated by reference as if set forth in its entirety herein.

### BACKGROUND OF THE INVENTION

1. Field of the Invention

The present invention relates to a personal or animal cleaning product and more specifically to a personal or animal cleaning product having several optional attachments that can be operated with one hand. The invention further includes a method of bathing a human or animal with a washing device that allows for one handed or hands free soaping, rinsing, and washing.

2. Discussion of Related Art

Typically people use brushes for bathing and showering. There are brushes which spray water. There are also brushes which have a reservoir for holding a detergent which is released to more conveniently aid in cleaning instead of having to lather with soap then brush.

These, however have several different designs. One such design allows a constant detergent flow with the water. This tends to use the detergent even when not required.

Another design allows the detergent to be turned on and off, but requires two hands to operate. Even though functional, it is difficult to use for those older or disabled people who may need an arm to balance or hold them up during showering. Letting go of a support to turn the water on or off is not easy for older or handicapped people.

Those who are bathing small children must hold the child at times while washing them. This is especially true if the child does not wish to be bathed. This again leaves one arm free for washing.

Many people have animals which also require bathing and scrubbing. The scrubbing product described above works with animals as well. Since the animal owner typically has to hold the animal while washing it, they have only one hand available for operating the scrubbing product. Letting go of the animal typically results in the animal trying to escape the bath.

Currently, there is a need for a personal or an animal scrubbing product which is easy to operate and also may be operated with a single hand, and may be operated using a mount to provide a hands free soap shower, allowing both hands to be used to wash the human or animal.

### SUMMARY OF THE INVENTION

One embodiment of the present invention is a washing device [1000] designed for single-hand operation for connecting to a fluid hose [3] comprising:
a) a housing [1100] capable of being held by one hand;
b) a supply line [1010] capable of directing fluid flow through the housing [1100];
c) a hose connection [1030] for causing a fluidic connection between the fluid hose [3] and the supply line [1010];
d) a head section [1140] having a plurality of nozzles [1710];
e) an additive container [1600] having a container inlet [1610] and a container outlet [1630] leading to the nozzle outlets, for holding an additive and releasing the additive through the container outlet [1630] to the nozzle outlets when fluid enters through the container inlet [1610]; and
f) a three-way roller valve [1900] designed for single-hand operation, coupled to the supply line [1010], the additive container inlet [1610], and the nozzles [1710], having three positions,
   i. a first position preventing the flow of fluid from the supply line [1010] through the fluid valve [1210],
   ii. a second position allowing fluid flow from the supply line [1010] only through the nozzles [1710], and
   iii. a third position allowing fluid flow from the supply line [1010], through the nozzles [1710], and through the additive container inlet [1610] releasing the additive through the container outlet [1630] to the nozzles [1710] to be mixed with the fluid from the supply line [1010].

The present invention may also be embodied as a washing device [1000] for connecting to a fluid hose [3] comprising:
a) a housing [1100] having a head section [1140] and a handle section [1120], wherein the handle section [1120] is capable of being held by one hand;
b) a supply line [1010] capable of directing fluid flow through the housing [1100];
c) a hose connection [1030] for causing a fluidic connection between said fluid hose [3] and the supply line [1010];
d) a plurality of nozzles [1710] for spraying out fluids provided to them;
e) an additive container [1600] having a container inlet [1610] and a container outlet [1630] coupled to at least one of the nozzles [1710] for holding an additive and releasing the additive through the container outlet [1630] when fluid enters through the container inlet [1610];
f) a fluid valve [1210] having an input fluidically coupled to the supply line [1010], and a fluid line outlet [1271] coupled to the nozzles [1710], the fluid valve [1210] capable of operating in:
   i. a first position, thereby preventing the flow of fluid from the supply line [1010] through the fluid valve [1210], and
   ii. a second position allowing fluid flow from the supply line [1010] through the fluid valve [1210] to the fluid line outlet [1271] and out of the nozzles [1710];
g) an additive valve [1240] having an input fluidically coupled to the fluid line outlet [1271] of the fluid valve [1210] and an output fluidically coupled to nozzles [1710] capable of operating in:
   i. a first position, preventing fluid flow through the fluid valve [1210], and
   ii. a second position allowing fluid flow from the output of the fluid valve [1210] to pass through the additive valve [1240], to an additive line output [1281], to the container inlet [1610] causing an additive to be forced out of container outlet [1630] and to the nozzles [1710].

The present invention may also be embodied as a washing device [1000] intended for one-hand operation comprising:
a) a housing having a handle section [1120] and a head section [1140],
b) a hose connection in the handle section [1120] fluidically connected to a fluid source;
c) an additive container [1600] for carrying an additive;
d) a plurality of nozzles [1710];
e) at least one valve in the handle section [1120] capable of being operated by one hand, fluidically coupled to the hose connection, the valve having at least three settings,
   i. the first setting for preventing the flow of fluid; [1710]; and
   ii. a second setting for allowing the flow of fluid to the nozzles [1710]; and
   iii. a third setting allowing the flow of fluid out of the nozzles [1710] and also allowing fluid to flow into the additive container causing additive to flow out of the nozzles [1710].

The present invention embodies a one handed or hands free method of washing a human or animal, the method including the steps of:
providing a washing device, the washing device [1000] intended for one-hand valve operation and hands free washing comprising:
a) a housing having two sides, a first end and a second end, a front surface and a back surface, the housing having a handle section [1120] at the first end and a head section [1140] at the second end, the front surface of the handle section [1120] being shaped to receive fingers of a user and the back surface shaped to receive a thumb of a user;
b) a hose connection in the handle section [1120] fluidically connected to a fluid source;
c) an additive container [1600] for carrying an additive;
d) a plurality of nozzles [1710];
e) at least one valve located on the back surface within a length of a human adult thumb from the handle section [1120] capable of rolling about a side to side axis and capable of being operated by a thumb of one hand of a user, fluidically coupled to the hose connection, the at least one valve enabling the following settings,
   i. a first setting for preventing the flow of fluid;
   ii. a second setting for allowing the flow of fluid to the nozzles [1710]; and
   iii. a third setting allowing the flow of fluid out of the nozzles [1710] and also allowing fluid to flow into the additive container causing additive to flow out of the nozzles [1710];
providing a selectively mountable washing device mount, said washing device mount adaptable to hold the washing device in place to provide a directed stream of fluid from the washing device;
connecting the selectively mountable washing device mount to a wall or water source pipe, or other static or selectively static object to hold the mount in place;
connecting the washing device to the selectively mountable washing device mount either before during or after “operating the at least one valve” step washing device is connected to the mount;
with one hand, operating the at least one valve of the washing device while holding the washing device [1000], or operating the at least one valve with one hand while the washing device [1000] is held by the mount; and
washing a human or animal with at least the one hand while the washing device is operating in the first setting, the second setting, or the third setting;
   while using at least one hand for another purpose (such as holding the human or animal, or washing the human or animal) operating the at least one valve of the washing device to change among the first setting, the second setting, or the third setting while holding the washing device [1000], or operating the at least one valve with an other hand of a person to change among the first setting, the second setting, or the third setting while the washing device [1000] is held by the mount.

### OBJECTS OF THE INVENTION

It is an object of the present invention to provide a washing device which allows one to turn the fluid on or off with one hand.

It is another object of the present invention to provide a washing device which allows a user to turn an additive to the fluid on and off with a single hand.

It is another object of the present invention to provide a washing device which allows a user to operate the fluid independent of the additive.

It is another object of the present invention to provide an aesthetically pleasing washing device which is light and compact.

It is another object of the present invention to provide a washing device which is simple to operate.

It is another object of the present invention to provide a washing device which is easily cleaned.

It is another object of the present invention to provide a washing device which is easy to fill with the additive container with an additive.

It is another object of the present invention to provide a washing device which may be a hand held device or operate as a stationary shower head.

It is another object of the present invention to provide a washing device which includes changeable washing head having brushes, loofa-type material, sponge material or cloth material.

It is another object of the present invention to provide a washing device which includes changeable washing head having a screen.

It is another object of the present invention to provide a washing device which includes an air intake capable of causing foaming.

It is another object of the present invention to provide a washing device which includes an agitator capable of causing foaming.

It is another object of the invention to provide a one hand, one thumb, or hands washing device.

### BRIEF DESCRIPTION OF THE DRAWINGS

The advantages of the instant disclosure will become more apparent when read with the specification and the drawings, wherein:

FIG. 1 is a perspective view of one embodiment of the present invention.

FIG. 2 is a plan view from the top showing a partially cut-away washing device 1000 according to one embodiment of the present invention.

FIG. 3 is a side elevational view of a cross section of the washing device 1000 of FIG. 1.

FIG. 4 is an enlarged view of the valve assembly 1200 of the embodiment of the present invention shown in FIGS. 1 and 2 with the fluid valve in an “up” position.

FIG. 5 is an enlarged view of the valve assembly 1200 of the embodiment of the present invention shown in FIGS. 1, 2 and 3 with the fluid valve in a “down” position and the additive valve in an “up” position.

FIG. 6 is an enlarged view of the valve assembly 1200 of the embodiment of the present invention shown in FIGS. 1, 2, 3 and 4 with both valves in a “down” position.

FIG. 7 is a perspective view of another embodiment of the present invention.

FIG. 8 is a side elevational view of a cross section of the washing device 1000 of FIG. 7.

FIG. 9 is a side elevational view of a cross section of another embodiment of the washing device 1000 according to the present invention showing a three-way roller valve in its first position.

FIG. 10 is a side elevational view of a cross section of another embodiment of the washing device 1000 according to the present invention showing a three-way roller valve in its second position.

FIG. 11 is a side elevational view of a cross section of another embodiment of the washing device 1000 according to the present invention showing a three-way roller valve in its third position.

### DETAILED DESCRIPTION OF THE INVENTION

### Structure

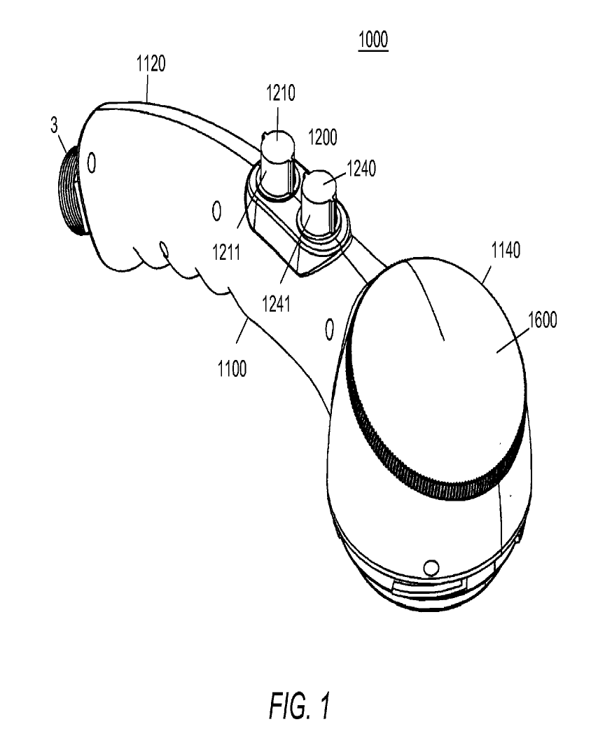

FIG. 1 is a perspective view of one embodiment of the present invention.

Housing 1100 has a handle section 1120 and a head section 1140. A hose (not shown) is connected to a hose connection 1030 of the handle section 1120. A fluid, being water in this embodiment, is supplied to washing device 1000 through hose connection 1030.

Fluid flows from hose connection 1030 into a valve assembly 1200. Valve assembly 1200 employs at least two valves. The first is a fluid valve 1210 which either stops the flow of the fluid or allows the fluid to flow through it to an additive valve 1240, when a fluid button 1211 is depressed.

The additive valve 1240 allows the flow of additives, such as a shampoo or medication to flow only when the additive button 1241 is depressed and fluid is flowing into the additive valve 1240. The additive is held in a refillable container 1600. Container 1600 is attached to housing 1100 in any number of known ways, including, but not limited to, a hinged mechanism, a threaded attachment, a friction fit attachment, attached by snaps, clips or other known attachment devices.

The fluid, or the fluid and additive mixture are then sprayed out of nozzles (not shown) of a head section 1140. This head section 1140 may have different types and designs of nozzle on its underside. These nozzles may be adjusted to have different spray patterns.

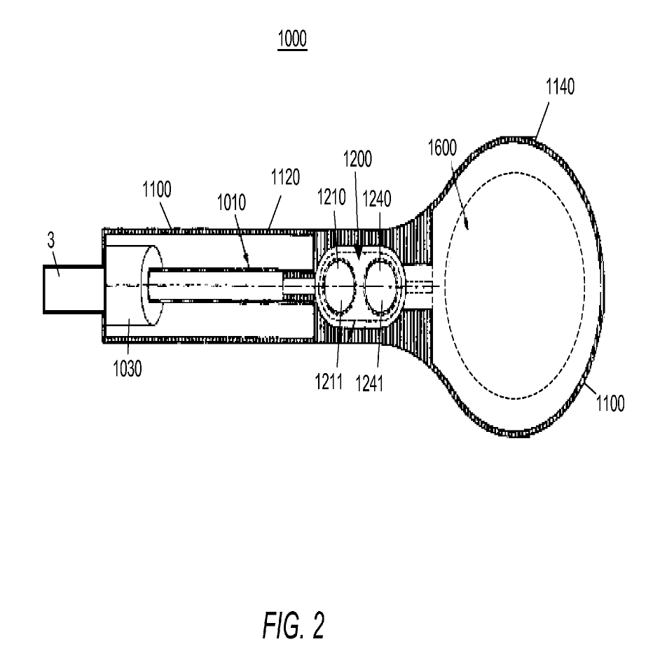

FIG. 2 shows a plan view of the washing device 1000 as viewed from above with portions of housing 1100 cut-away view to reveal inner structures. A hose 3 is connected to a hose connection 1030 of the handle section 1120. Water is supplied to washing device 1000 through hose 3 through hose connection 1030 to a supply line 1010. Supply line 1010 can be seen inside of washing device 1000 in this view.

Fluid flows through the supply line 1010 into the valve assembly 1200. Valve assembly 1200 employs at least two valves. The first is a fluid valve 1210 which either stops the flow of the fluid, or allows the fluid to flow through it to an additive valve 1240, when a fluid button 1211 is depressed.

The additive valve 1240 allows the flow of additives only when the additive button 1241 is depressed and fluid is flowing into the additive valve 1240.

As stated above, the fluid, or the fluid and additive mixture are then sprayed out of a head section 1140.

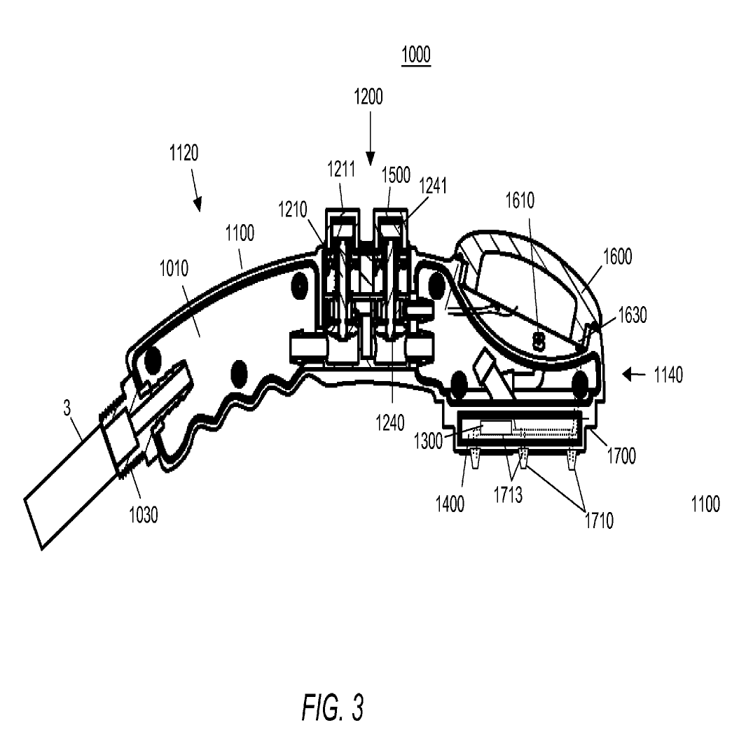

FIG. 3 is a side elevational, cross sectional view of the washing device 1000. Cleaning fluid from a hose 3 enters through the hose connection 1030 and passes through the supply line 1010 entering the valve assembly 1200. (Two valves are shown in this embodiment, however it is understood that any number of additional valves may be added to this embodiment.)

The fluid valve 1210 and the additive valve 1240 are operated by two buttons covered and protected by the flexible keypad 1500. The fluid button 1211 controls the flow of cleaning fluid to the additive valve.

The additive button 1241 controls the flow of additive from the refillable additive container 1600 to mix with the cleaning fluid in a mixing chamber 1400 and to create foam. The mixture is then forced out of nozzle 1710. Optionally a changeable head 1700 is employed which may include a brush, pin brush, sponge, loofa-type scrubber, cloth, or cloth-like material or other known grooming devices. The changeable head 1700 may also include a screen allowing the fluid to pass through it.

A screen may also be employed at or near the nozzles 1710.

In this embodiment, the additive and fluid are mixed in a mixing chamber 1400 before being sprayed out of nozzles 1710.

In an alternative embodiment, the additive passes through additive tubes 1713 to or near nozzles 1710. The fluid is also passed to nozzles 1710. Both are then sprayed out of nozzles 1710.

In an optional embodiment, an agitator 1300 may be used which further mixes and foams the mixture. In this embodiment, it is shown as a rotating wheel 1300 driven by the fluid pressure.

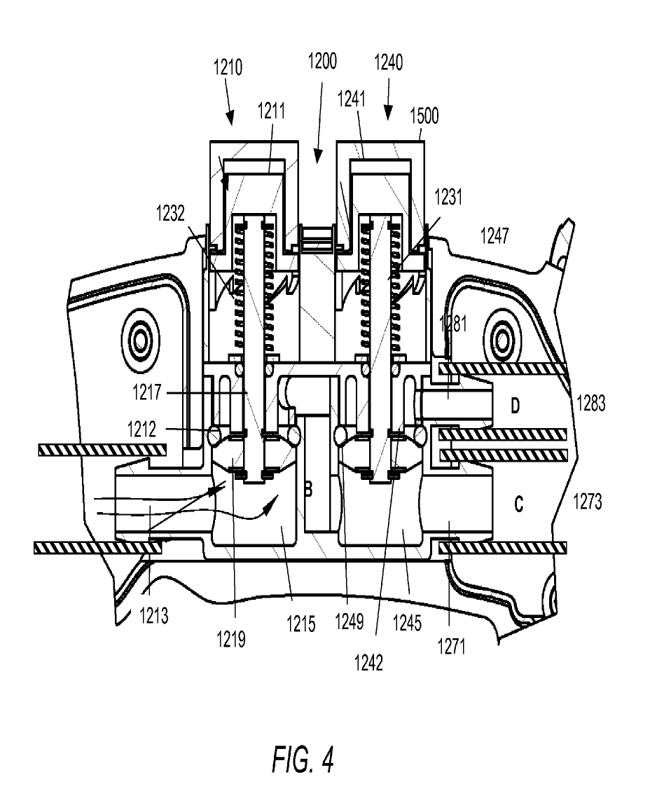

FIG. 4 is an enlarged view of one embodiment of the valve assembly 1200. It controls the flow of fluid and additive through the washing device (1000 of FIGS. 1 and 2). It consists of two connected chambers, the fluid valve cylinder 1215 and an additive valve cylinder 1245. Cylinders 1215, 1245 contain seals 1219, 1249 pressing against walls of the cylinder preventing the flow of liquid past the seals 1219, 1249.

Fluid button 1211 is connected to fluid valve shaft 1217. Similarly, additive button 1241 is connected to additive valve shaft 1247.

The shafts 1217, 1247 are connected to their respective seals 1219, 1249. By pressing on the buttons 1211, 1241, it puts the valve into an “up” or “down” position.

When fluid button 1211 is pressed, a first clicking mechanism 1231 toggles between positions to move fluid valve shaft 1217 and fluid valve seal 1219 of fluid valve 1210 alternatively between the “up” and “down” positions.

Additionally, a valve stops, 1212, 1242 stop the motion of the fluid valve seal 1219, and the additive valve seal 1249 at its maximum upward travel, respectively.

In an alternative embodiment, there may be stops used to limit the extent of the travel of seals 1219, 1249 in a downward direction.

When additive button 1241 is pressed, a second clicking mechanism 1232 toggles between positions to move additive valve shaft 1247 and additive valve seal 1249 of additive valve 1240 alternatively between the “up” and “down” positions. Clicking mechanisms 1231, 1232 operate in a manner similar to that of a typical ball point pen.

Fluid valve 1210 and additive valve 1240 are both shown in the “up” position.

With fluid valve 1210 in the ‘up’ position, fluid comes in from fluid inlet 1010 through fluid inlet 1213, but is trapped below fluid valve seal 1219, stopping the flow of fluid.

Since liquid cannot flow past fluid seal 1219, fluid is kept in the fluid valve cylinder 1215 and not allowed to flow into additive cylinder 1245.

At this point it is irrelevant what position additive valve 1240 is in since it directs fluid passing into it.

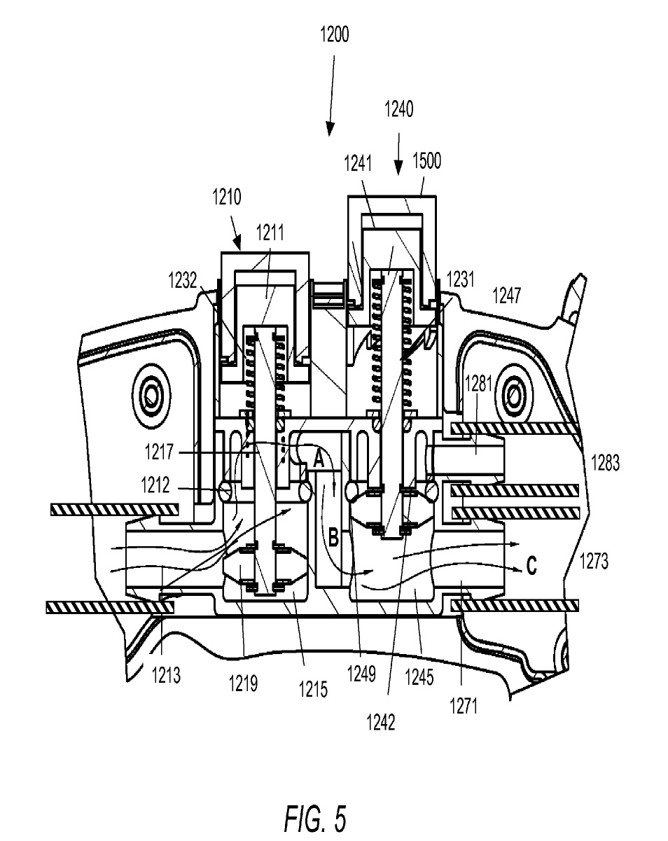

FIG. 5 is another enlarged cutaway view of the valves shown in FIGS. 3 and 4. In FIG. 5, fluid valve 1210 is in the ‘down’ position, opening a passageway to additive valve 1240. Fluid flows in the direction marked by arrows “A” and “B”.

Since additive valve 1240 is in the ‘up’ position, fluid from fluid valve 1210 is allowed to flow into cylinder 1245 down to seal 1249, but not past it since it makes a fluid-tight seal with the walls of cylinder 1245. Fluid then exits the valves through fluid line outlet 1271. Fluid therefore follows the path indicated by arrow “C”.

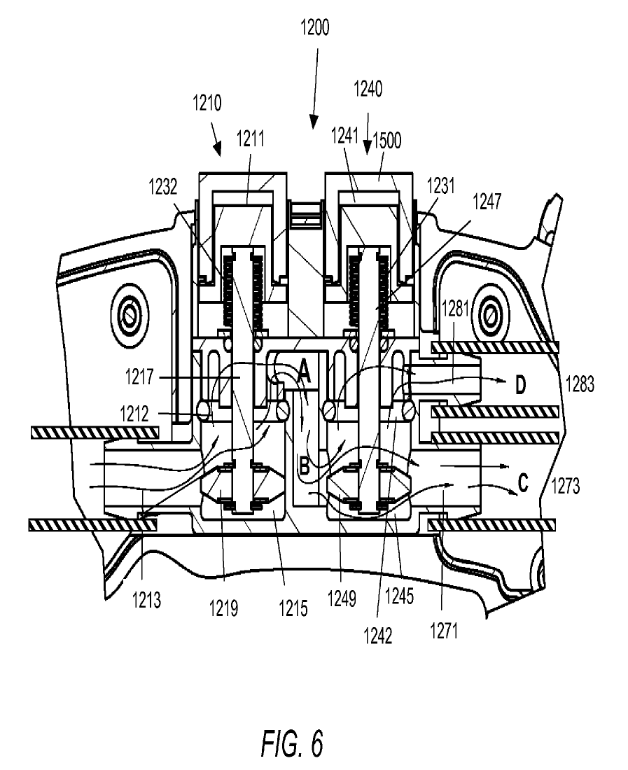

In FIG. 6, fluid valve 1210 is in the ‘down’ position allowing fluid flow into additive valve 1240. Here additive valve 1240 is also in the ‘down’ position, allowing fluid to pass through additive valve cylinder 1245 and exit by both fluid line outlet 1271 and additive line outlet 1281.

The fluid flow is therefore as indicated above with additional flow out of the additive line outlet 1281 as indicated by arrow “D”.

The fluid passes from fluid line outlet 1271 through fluid line 1273 and into the mixing chamber (1400 of FIG. 3).

Additive line outlet 1281 directs the cleaning fluid into a refillable additive container 1600 through a passageway which is out of the plane of this sectional view and therefore not shown here. Additive container 1600 hold any additive intended to be mixed with the fluid. This may be a detergent, soap, treatment, medication, solvent or other fluid intended to be mixed with the fluid.

The fluid directed into the additive container 1600 through a container inlet 1610 increases the pressure inside of additive container 1600 causing the additive to be forced out of a container outlet 1630 into mixing chamber 1400. Aperture 1630 may be fitted with a minimal opening force valve which closes when there is no pressure in additive container 1600 preventing the additive from leaking out. This valve then opens when there is some degree of pressure in additive container 1600, allowing the additive to flow into mixing chamber 1400.

Referring back to FIG. 3, mixing chamber 1400 may optionally include an agitator 1300, shown as a wheel here. The wheel is rotated by the force of the fluid escaping from fluid outlet line 1271. The agitator 1300 operates to mix the fluid with the additive. It also may operate to agitate the mixture to create foam for washing.

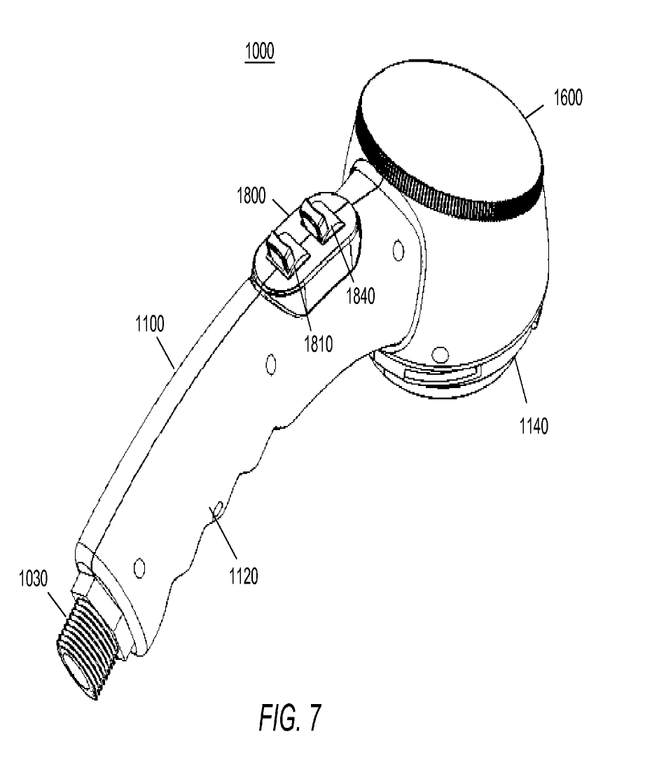

FIG. 7 is a perspective view of another embodiment of the present invention 1000. This embodiment employs a roller valve assembly 1800. The roller valve assembly 1800 includes a fluid valve 1810 and an additive valve 1840. This embodiment includes a similar housing 1100 having a handle section 1120, a head section 1140 and an additive container 1600.

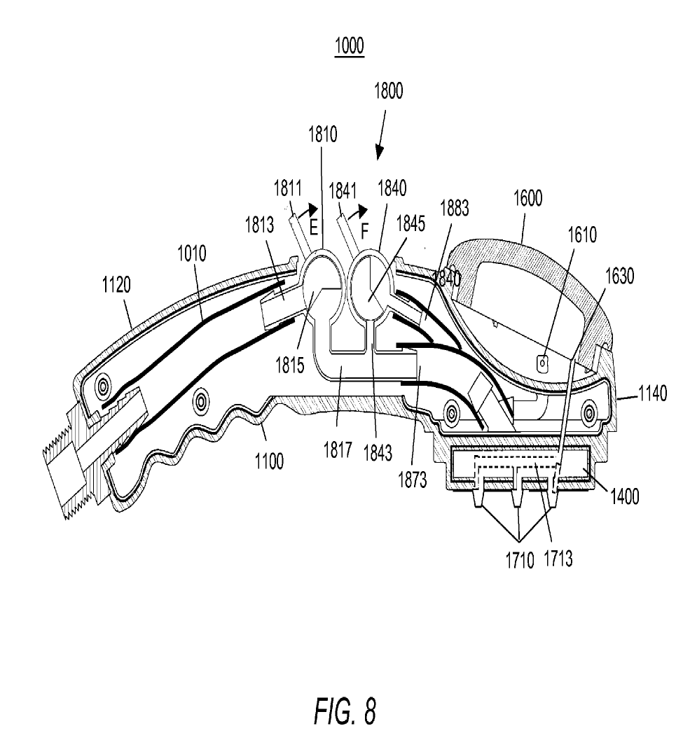

FIG. 8 is a side elevational view of a cross section of the washing device 1000 of FIG. 7.

The parts having the same number in previous figures has the same function, and need not be repeated here.

However, the roller valve assembly 1800 replaces the valve assembly 1200 of the previous embodiment. Fluid from supply line 1010 enters fluid valve inlet 1813. A roller 1815 has a channel cut through it indicated here in cross section. In its current “closed” position, no fluid is allowed to pass through fluid valve 1810.

If tab 1811 is rotated in the direction of arrow “E”, its “open” position, fluid valve inlet 1813 is connected to a fluid valve outlet 1817 causing fluid to flow through fluid valve 1810, though fluid valve outlet 1817 into fluid line 1873 and into head section 1140. In one embodiment, fluid from fluid line 1873 passes directly out of nozzles 1710.

In an alternative embodiment, fluid from fluid line 1873 passes into mixing chamber 1400, then out of nozzles 1710.

An additive valve 1840 has an additive valve inlet 1843 which connects to fluid valve outlet 1817. Additive valve 1840 also is connected to an additive line 1883. Additive line 1883 leads to container inlet 1610 of additive container 1600. Additive valve 1840 has a roller 1845 connected to a tab 1841. In the current “closed” position, as shown, roller 1845 prevents fluid from additive valve inlet 1843 from flowing to additive line 1883.

As tab 1841 is rotated in the direction of arrow “F”, it reaches a second or “open” position where fluid from fluid additive valve inlet 1843 is allowed to flow through additive line 1883 and into container inlet 1610. This causes pressure forcing additive out of additive container 1600 through container outlet 1630. In one embodiment, the additive flows directly out of nozzles 1710 through additive tubes 1713.

In an alternative embodiment, the additive is passed to a mixing chamber 1400 to be mixed with the fluid prior to be sprayed out of nozzles 1710.

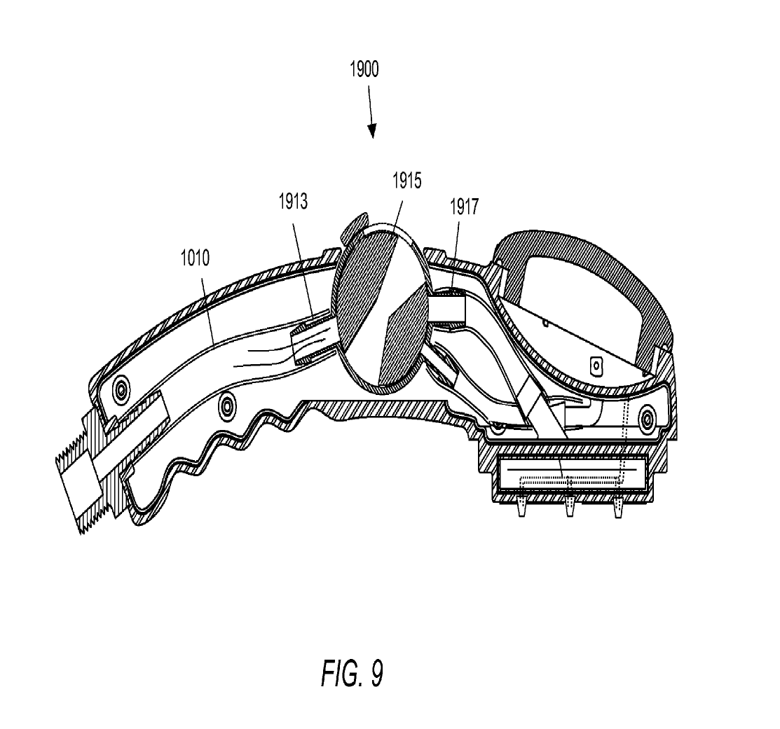

FIG. 9 is a side elevational view of a cross section of another embodiment of the washing device 1000 according to the present invention.

The parts having the same number in previous figures has the same function, and need not be repeated here.

In this embodiment, a single three way roller valve 1900 replaces the fluid valve 1810 and additive valve 1840 of the previous embodiment. Fluid from supply line 1010 enters fluid valve inlet 1913. A roller 1915 has at least two channels cut through it indicated here in cross section. In its current “closed” position, no fluid is allowed to pass through three-way valve assembly 1900.

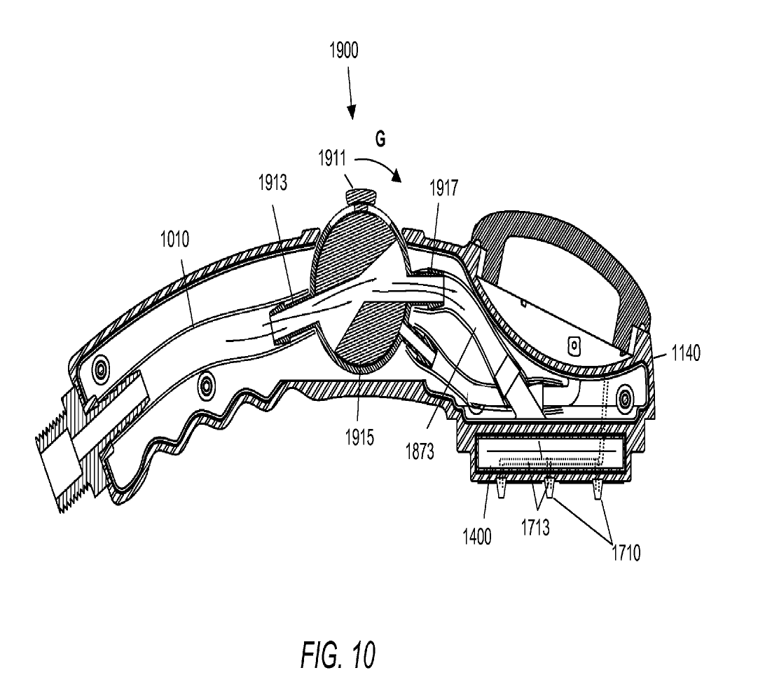

In FIG. 10, if tab 1911 is rotated in the direction of arrow “G” to its “fluid only” position, valve inlet 1913 is connected to a fluid outlet 1917 causing fluid to flow through three-way roller valve 1900, through fluid outlet 1917 into fluid line 1873 and into head section 1140. In one embodiment, fluid from fluid line 1873 passes directly out of nozzles 1710.

In an alternative embodiment, fluid from fluid line 1873 passes into mixing chamber 1400, then out of nozzles 1710.

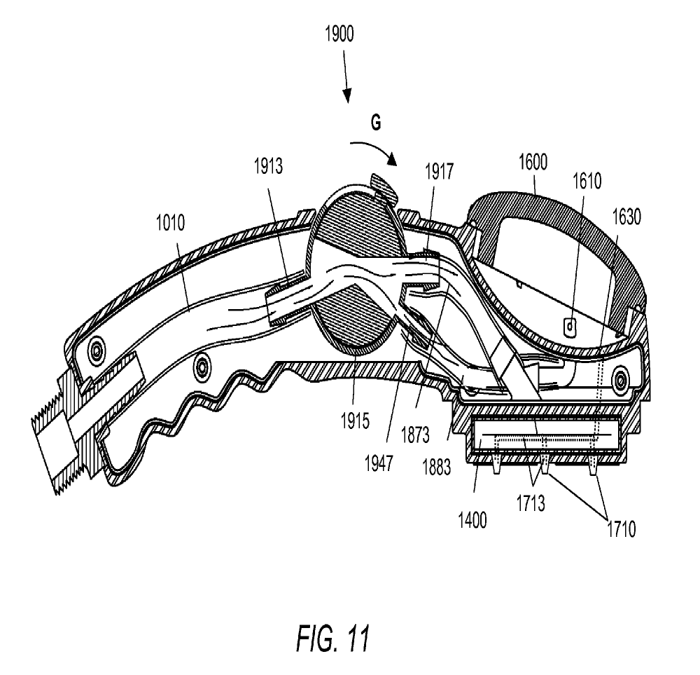

In FIG. 11, tab 1911 of three-way roller valve 1900 may be rotated further in the direction indicated by arrow “G” to turn the roller 1915 such that the internal passages line up and connect the valve inlet 1913 with both the fluid output 1917 and the additive output 1947. Additive output 1947 is connected to an additive line 1883. Additive line 1883 leads to container inlet 1610 of additive container 1600.

This causes pressure forcing additive out of additive container 1600 through container outlet 1630. In one embodiment, the additive flows directly out of nozzles 1710 through additive tubes 1713.

In an alternative embodiment, the additive is passed to a mixing chamber 1400 to be mixed with the fluid prior to be sprayed out of nozzles 1710.

In alternative embodiments, agitator 1300 may be a series of flat baffles, or other turbulence creating structures causing mixing and foaming.

In still another embodiment, mixing chamber 1400 may include a small air inlet into mixing chamber preferably in a narrow section of the fluid flow. By the venture effect, an air inlet near a fast rushing fluid typically causes a partial vacuum at the air inlet sucking in air. The air mixes with the fluid creating a foaming effect. The air inlet may be designed to have an adjustable opening size and/or have a one way air flow valve allowing air to flow into the mixing chamber but not out.

It is understood that the valves described herein may vary and can be any valve capable of performing the intended function of allowing, or stopping flow of fluid, allowing the user to select additive only, select additive and water, and/or a combination thereof. Preferably, the valve is capable of being operated with one hand while the same hand is holding the washing device.

Use

Since the washing device has a thin design, it can easily be held by the user with one hand. This includes older and handicapped users. It also includes animal owners using one arm to hold the animal.

Both the fluid valve 1210 and the additive valve 1240 are toggle design valves allowing one-press operation. They do not have to be continually held to cause fluid flow as do other devices in the prior art.

Similarly, the additive valve does not need to be continually held to cause the flow of additive as do other designs in the prior art.

In an additional embodiment of the present invention, it would be beneficial to employ a larger head section 1140 of FIGS. 1 and 2 to be used on larger animals.

The invention further includes a method of bathing comprising the following steps. The washing device described herein is provided and functionally connected to a water source. A selectively mountable washing device mount is provided. Said washing device mount is adaptable to hold the washing device in place to provide a directed stream of fluid from the washing device. Said mount being connectable to a wall or water source pipe, or other static or selectively static object to hold the mount in place.

With one hand, a user operates a valve located on the washing device while holding the washing device [1000]. Alternately, a user operates the valve with one hand while the washing device [1000] is held by the mount.

The valve of the washing device [1000] being the valves discussed herein, which are within the reach or length of a human thumb and capable of being operated with the thumb of the hand holding the washing device [1000] while the washing device [1000] is being held with said hand—without the assistance of an other hand. Said valves include the three-way roller valve [1900], the fluid valve [1210], additive valve [1240], and/or the at least one roller valve located on the back surface within a length of a human thumb from the handle section [1120].

At some point during the washing process, (either before during or after operation of the valve steps(s) washing device is connected to the mount. When the bathing takes place.

In one embodiment of the invention, the user operates the valve as described in the above “operates a valve” step to stop or start the flow of fluid through the washing device [1000].

In another embodiment of the invention, the user operates the valve as described in the above “operates a valve” step to provide a stream of fluid containing an additive, such as soap from the washing device [1000].

In another embodiment of the invention, the user operates the valve as described in the above “operates a valve” step to provide a stream of fluid containing no additive (just water) from the washing device [1000].

In another embodiment of the invention, the user operates the valve as described in the above “operates a valve” step to select among a plurality of settings, which include, flow of fluid, no flow of fluid, flow of water and flow of water and additive stream, flow of just water, flow of water and additive stream.

In another embodiment of the invention, the method includes the step of washing a human or animal by applying one or more hands or limbs to the human or animal without holding the washing device [1000], the washing device [1000] being held by the mount. The user reaching with one hand or limb to operates the valve as described in the above “operates a valve” step to select among a plurality of settings, which include, flow of fluid, no flow of fluid, flow of water and flow of water and additive stream, flow of just water, flow of water and additive stream.

An additive such as soap may or may not be placed into the additive container of the washing device. In the instance no additive is placed into the additive container, the user may provide an aerated stream of water by operates the valve as described in the above “operates a valve” step to direct water through the additive line output causing an aerated stream to flow from the washing device [1000].

In another embodiment of the invention, the washing device [1000] has at least one nozzle [1710] capable of providing a stream which is different in feel from the stream of another of the nozzles [1710] due to the design, shape, size, flow rate, or flow pattern of the one nozzle [1710]. An example includes a massager nozzle, or other variations of spray nozzles known in the art. The user operates the valve as described in the above “operates a valve” step to select among a plurality of settings, which include, flow of fluid, no flow of fluid, flow of water and flow of water and additive stream, flow of just water, flow of water and additive stream, and any combination of nozzles [1710] capable of providing a stream which is different in feel from the stream of another of the nozzles due to the design, shape, size, flow rate, or flow pattern of the one nozzle [1710].

The invention may be used as a hand held or a mounted adjustable position showerhead for showering or bathing humans or animals. The invention may be used as a one-handed or NO-handed soap shower. The invention simplifies the process of someone bathing himself or herself and/or for a caregiver to use on a human or animal.

Using the invention, human beings regain independence in self-care and bathing where once they had to rely on a caregiver. Caregivers who once bathed their patients, may now, with the invention, simply provide “set up” assistance for their client or patients, i.e. laying out bathing materials required by the client with no other assistance. In this way the client can be counted as Independent.

In-line function controls on the handle allows the user to control the water from Rinse to Soap to Off and also control the spray patterns (examples: rain fall and massage, etc.) with the action of one hand and one thumb. The ease of this control is designed for those with disabilities or low hand strength and universal appeal for ease of use for any user.

Thick handle provides a normal ergonomic and comfortable grip (Great for those with hand disabilities). Non-slip handle grip Combined with the thick handle, the non-slip grip provides a more controlled and comfortable grip while in a wet environment. (Great for those with or with out hand disabilities). Right or Left handed user designed in mind for the comfort and control of a right or left-handed user. Removable and Non-slip grip Reservoir Cap may be attached and removed with an open palm and short turn for ease of changing to different bathing soaps or shampoo's while in the wet environment like a shower or bathtub. The reservoir has a large window to see the additive and water mixing and spinning inside the reservoir. Reservoir for Shower Gel, Soap or Shampoo for a favorite Shower Gel, Shampoo or Soap. This reservoir is built right into the invention. Remove the reservoir cover and add up to a favorite Shower Gel or Shampoo or Soap. The invention provides aerated bathing foam, and a lasting fragrance on the individual and in the bathroom. The reservoir is self-cleaning.

Attachments

The invention may have many attachments: loofa, sponge, washcloth, soft exfoliation brush, Pumice stone and finger sponge for examples. All attachments have a Non-slip grip so it may be attached and removed with a short turn for the many types of bathing needs while in the wet environment such as a shower or bathtub. All attachments are dishwasher safe and the washcloth cover is clothes washer and dryer safe. The invention also has optional disposable attachments: loofa, sponge, washcloth, soft exfoliation brush, Pumice stone and finger sponge for examples.

Spray Patterns

There are many spray patterns controlled buy a in-line switch and or on the nozzle face it self. One is a drenching rain-shower spray for a refreshing, invigorating and energizing rinse and the other is a soothing aerated massaging spray with two functions. The first function infuses oxygen with water that gives your body and hair a mind soothing, stress release and relaxing shower. And the second function is used with your favorite shower gel, soap or shampoo giving you a sensory pleasing experience. The oxygen aeration mixed with your favorite shower gel or shampoo with fragrances will create a great aromatic sensory pleasing experience during bathing but will also provide a sense of cleanliness.

Fill the soap reservoir with your favorite shower gel, shampoo or soap, move the In-line function control to soap and attach washing device to the shower mount for a hands free Soap or Shampoo shower for your body or hair.

Regular Showerhead Option

Move the washing device in-line controls on the handle to the different spray functions while attached or unattached to the adjustable position shower mount or pluming and use as you would a regular showerhead.

Height Extension

Because of the length of the unit as it sits in the adjustable position mounting bracket, it will sit higher then the position of a normal showerhead giving taller people the extra height needed for them to enjoy a normal shower. For others, the flexibility to adjust the shower head to the preferred direction. Allowing one to create many different angles and directions of the spray. Including the much desired rainfall effect.

Included with this application is an appendix of information concerning developments of the present invention.

Therefore, the present invention describes a novel design which is uniquely adapted to the older user, the handicapped user and the user which desires to have one hand free such as an animal owner.

1. A washing device [1000] designed for single-hand operation for connecting to a fluid hose [3] comprising:
a) a housing [1100] having two sides, a first end and a second end, a front surface and a back surface;
b) a handle section [1120] at the first end capable of being held by one hand;
b) a supply line [1010] capable of directing fluid flow through the housing [1100];
c) a hose connection [1030] for causing a fluidic connection between the fluid hose [3] and the supply line [1010];
d) a head section [1140] at the second end having a plurality of nozzles [1710];
e) an additive container [1600] having a container inlet [1610] and a container outlet [1630] leading to the nozzle outlets, for holding an additive and releasing the additive through the container outlet [1630] to the nozzle outlets when fluid enters through the container inlet [1610]; and
f) a three-way roller valve [1900] located on the back surface within a length of a human thumb from the handle section [1120], capable of rolling about an axis which passes from side to side, causing the valve to be operated by rolling an exposed surface of the three-way roller valve toward the first end and toward the second end allowing simple single-hand operation, the three-way roller valve [1900] being coupled to the supply line [1010], the additive container inlet [1610], and the nozzles [1710], having three positions,
i. a first position preventing the flow of fluid from the supply line through the fluid valve [1210],
ii. a second position allowing fluid flow from the supply line [1010] only through the nozzles [1710], and
iii. a third position allowing fluid flow from the supply line [1210], through the nozzles [1710], and through the additive container inlet [1610] releasing the additive through the container outlet [1630] to the nozzles [1710] to be mixed with the fluid from the supply line [1010].

2. The washing device [1000] of claim 1 wherein the head section [1140] further comprises:
a changeable scrubbing brushes [1730].

3. The washing device [1000] of claim 1 wherein the head section [1140] further comprises:
a changeable washing sponges [1730].

4. The washing device [1000] of claim 1 wherein the head section [1140] further comprises:
a changeable loofa-like washing material [1730].

5. The washing device [1000] of claim 1 wherein the head section [1140] further comprises:
a changeable cloth material [1730].

6. A washing device [1000] for connecting to a fluid hose [3] comprising:
a) a housing [1100] having a head section [1140] and a handle section [1120], wherein the handle section [1120] has two sides, a front surface and a back surface, the front surface shaped to receive fingers of a user and the back surface shaped to receive a thumb of a user, the handle section [1140] is capable of being held by one hand;
b) a supply line [1010] capable of directing fluid flow through the housing [1100];
c) a hose connection [1030] for causing a fluidic connection between said fluid hose [3] and the supply line [1010];
d) a plurality of nozzles [1710] for spraying out fluids provided to them;
e) an additive container [1600] having a container inlet [1610] and a container outlet [1630] coupled to at least one of the nozzles [1710] for holding an additive and releasing the additive through the container outlet [1630] when fluid enters through the container inlet [1610];
f) a fluid valve [1210] located on the back surface within a length of a human thumb from the handle section [1120], having an input fluidically coupled to the supply line [1010], and a fluid line outlet [1271] coupled to the nozzles [1710], the fluid valve [1210] capable of being placed, and remaining in, without outside force:
i. a first position, thereby preventing the flow of fluid from the supply line [1010] through the fluid valve [1210], and
ii. a second position allowing fluid flow from the supply line [1010] through the fluid valve [1210] to the fluid line outlet [1271] and out of the nozzles [1710];
g) an additive valve [1240] located on the back surface within a length of a human thumb from the handle section [1120], having an input fluidically coupled to the fluid line outlet [1271] of the fluid valve [1210] and an output fluidically coupled to nozzles [1710] capable of being placed in, and remain in, without outside force:
i. a first position, preventing fluid flow through the fluid valve [1210], and
ii. a second position allowing fluid flow from the output of the fluid valve [1210] to pass through the additive valve [1240], to an additive line output [1281], to the container inlet [1610] causing an additive to be forced out of container outlet [1630] and to the nozzles [1710].

7. The washing device [1000] of claim 6 wherein the fluid valve [1210] is push-type toggle valve and further comprises:
a first clicking mechanism [1231] is coupled to a fluid button [1211] and the fluid valve [1210] for toggling the fluid valve [1210] when the fluid button [1211] is pressed between its first position and its second position.

8. The washing device [1000] of claim 6 wherein the additive valve is a push-type toggle valve and the washing device further comprises:
a second clicking mechanism [1232] coupled to the fluid button [1211] and the fluid valve [1210] for toggling the fluid valve [1210] when the fluid button [1211] is pressed to between its first position and its second position.

9. The washing device [1000] of claim 6 wherein the fluid valve [1210] is a roller-type valve.

10. The washing device [1000] of claim 6 wherein the additive valve [1240] is a roller-type valve.

11. The washing device [1000] of claim 6 wherein the fluid valve [1210] and the additive valve [1240] are designed to roll about an axis which passes from side to side of the housing, the valves are sized and positioned to be operated by a single human hand of a user holding the handle section [1140].

12. The washing device [1000] of claim 6 wherein the housing head section [1140] further comprises:
a changeable scrubbing brushes [1730].

13. The washing device [1000] of claim 6 wherein the housing head section [1140] further comprises:
a changeable washing sponges [1730].

14. The washing device [1000] of claim 6 wherein the housing head section [1140] further comprises:
a loofa-like washing material [1730].

15. The washing device [1000] of claim 6 wherein the housing head section [1140] further comprises:
a changeable cloth material [1730].

16-19. (canceled)

20. A method of bathing comprising the steps of:
providing a washing device, the washing device [1000] intended for one-hand valve operation and hands free washing comprising:
a) a housing having two sides, a first end and a second end, a front surface and a back surface, the housing having a handle section [1120] at the first end and a head section [1140] at the second end, the front surface of the handle section [1120] being shaped to receive fingers of a user and the back surface shaped to receive a thumb of a user;
b) a hose connection in the handle section [1120] fluidically connected to a fluid source;
c) an additive container [1600] for carrying an additive;
d) a plurality of nozzles [1710];
e) at least one valve located on the back surface within a length of a human adult thumb from the handle section [1120] capable of rolling about a side to side axis and capable of being operated by a thumb of one hand of a user, fluidically coupled to the hose connection, the at least one valve enabling the following settings,
i. a first setting for preventing the flow of fluid;
ii. a second setting for allowing the flow of fluid to the nozzles [1710]; and
iii. a third setting allowing the flow of fluid out of the nozzles [1710] and also allowing fluid to flow into the additive container causing additive to flow out of the nozzles [1710];
providing a selectively mountable washing device mount, said washing device mount adaptable to hold the washing device in place to provide a directed stream of fluid from the washing device;
connecting the selectively mountable washing device mount to a wall or water source pipe, or other static or selectively static object to hold the mount in place;
connecting the washing device to the selectively mountable washing device mount either before during or after “operating the at least one valve” step washing device is connected to the mount;
with one hand, operating the at least one valve of the washing device while holding the washing device [1000], or operating the at least one valve with one hand while the washing device [1000] is held by the mount; and
washing a human or animal with at least the one hand while the washing device is operating in the first setting, the second setting, or the third setting;
while using at least one hand for another purpose (such as holding the human or animal, or washing the human or animal) operating the at least one valve of the washing device to change among the first setting, the second setting, or the third setting while holding the washing device [1000], or operating the at least one valve with an other hand of a person to change among the first setting, the second setting, or the third setting while the washing device [1000] is held by the mount.
